(19) United States
(12) Patent Application Publication
(10) Pub. No.: US 2011/0007341 A1
(43) Pub. Date: Jan. 13, 2011

(54) CACHE CONTROL MECHANISM

(76) Inventors: Dennis Michael Carney, Louisville, CO (US); John Thomas Varga, Longmont, CO (US)

Correspondence Address: InfoPrint Solutions/ Blakely, 1279 Oakmead Parkway, Sunnyvale, CA, 94085-4040, US

(21) Appl. No.: 12/498,443

(22) Filed: Jul. 7, 2009

(51) Int. Cl. G06F 3/12; G06F 12/08; G06F 7/00

(52) U.S. Cl. 358/1.15; 711/113; 711/E12.019; 707/E17.055

(57) ABSTRACT

A method is disclosed. The method includes a compute node retrieving an object, the compute node receiving a local cache indicator associated with the object providing information as to whether the object is to be cached at the compute node and the compute node processing the object.

### FIELD OF THE INVENTION

This invention relates generally to the field of printing systems. More particularly, the invention relates to image processing in printing systems.

### BACKGROUND

Print systems include presentation architectures that are provided for representing documents in a data format that is independent of the methods that are utilized to capture or create those documents. One example of an exemplary presentation system, which will be described herein, is the (Advanced Function Presentation) AFP™ system developed by International Business Machines Corporation. According to the AFP system, documents may include combinations of text, image, graphics, and/or bar code objects in device and resolution independent formats. Documents may also include and/or reference fonts, overlays, and other resource objects, which are required at presentation time to present the data properly.

Once the documents are received at a printer, processing is performed to convert a document into a printable format. However, processing high-resolution images in an incoming data stream into a printable format typically involves highly compute-intensive operations (e.g., scaling, rotation, decompression, color conversion, etc.).

Further, it is common for a printer to frequently process repetitive images throughout a print job. For instance, a print job may include a full-page background image or a company logo that appears on every printed page. Therefore, print systems typically include caching mechanisms to store and reuse processed images.

However in print systems having several nodes, where processing is remotely performed in parallel, local caching is often complicated. For instance, when an image is rasterized by one of the nodes, it is often desirable to cache the rasterized version (e.g., bitmap) of the image to prevent having to rasterize the same image when it is subsequently used. Thus, a control mechanism at the print system recognizes how the image was received, and makes predictions as to whether the image will be used more than once.

A problem is that in some instances it is unlikely that a given image will be reused by the same node if the image is a saved page (e.g., five copies of a one thousand and one page book processed at a ten node system). Alternatively, if the image is referred to in an Intelligent Printer Data Stream (IPDS) Rasterize Presentation Object (RPO) command, which instructs the printer to rasterize a given object in advance of its use, there is a high likelihood that the image will be used again at the same node. Thus, it could be advantageous to cache the image at the node.

Accordingly, a mechanism to control caching is desired.

### SUMMARY

In one embodiment, a method is disclosed. The method includes a compute node retrieving an object, the compute node receiving a local cache indicator associated with the object providing information as to whether the object is to be cached at the compute node and the compute node processing the object.

In another embodiment, a printing system is disclosed. The printing system includes a print server and a printer. The printer includes a print head and a control unit having a disk database, a head node, and a compute node. The compute node retrieves an object from the disk database and receives a local cache indicator from the head node that is associated with the object providing information as to whether the object is to be cached at the compute node.

### BRIEF DESCRIPTION OF THE DRAWINGS

A better understanding of the present invention can be obtained from the following detailed description in conjunction with the following drawings, in which:

FIG. 1 illustrates one embodiment of a printing system;

FIG. 2 illustrates one embodiment of a control unit; and

FIG. 3 illustrates one embodiment of a compute node.

### DETAILED DESCRIPTION

A mechanism to efficiently process images in a print system is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

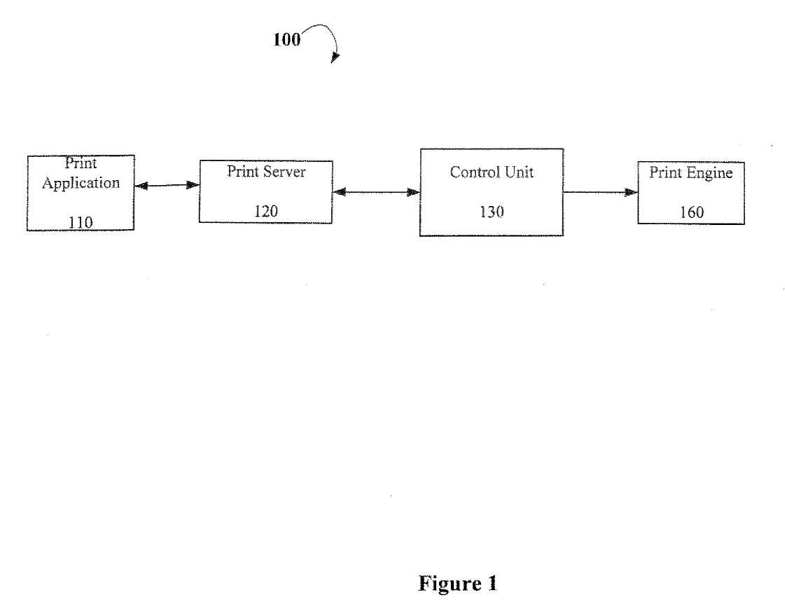

FIG. 1 illustrates one embodiment of a printing system 100. Printing system 100 includes a print application 110, a server 120, a control unit 130 and a print engine 160. Print application 110 makes a request for the printing of a document. In one embodiment, print application 110 provides a Mixed Object Document Content Architecture (MO:DCA) data stream to print server 120.

In other embodiments print application 110 may also provide PostScript (P/S) and PDF files for printing. P/S and PDF files are printed by first passing them through a pre-processor (not shown), which creates resource separation and page independence so that the P/S or PDF file can be transformed into an AFP MO:DCA data stream prior to being passed to print server 120.

According to one embodiment, the AFP MO:DCA data streams are object-oriented streams including, among other things, data objects, page objects, and resource objects. In a further embodiment, AFP MO:DCA data streams include a Resource Environment Group (REG) that is specified at the beginning of the AFP document, before the first page. When the AFP MO:DCA data streams are processed by print server 120, the REG structure is encountered first and causes the server to download any of the identified resources that are not already present in the printer. This occurs before paper is moved for the first page of the job. When the pages that require the complex resources are eventually processed, no additional download time is incurred for these resources.

Print server 120 processes pages of output that mix all of the elements typically found in presentation documents, e.g., text in typographic fonts, electronic forms, graphics, image, lines, boxes, and bar codes. The AFP MO:DCA data stream is composed of architected, structured fields that describe each of these elements.

In one embodiment, print server 120 communicates with control unit 130 via an Intelligent Printer Data Stream (IPDS). The IPDS data stream is similar to the AFP data stream, but is built specific to the destination printer in order to integrate with each printer's specific capabilities and command set, and to facilitate the interactive dialog between the print server 120 and the printer. The IPDS data stream may be built dynamically at presentation time, e.g., on-the-fly in real time. Thus, the IPDS data stream is provided according to a device-dependent bi-directional command/data stream.

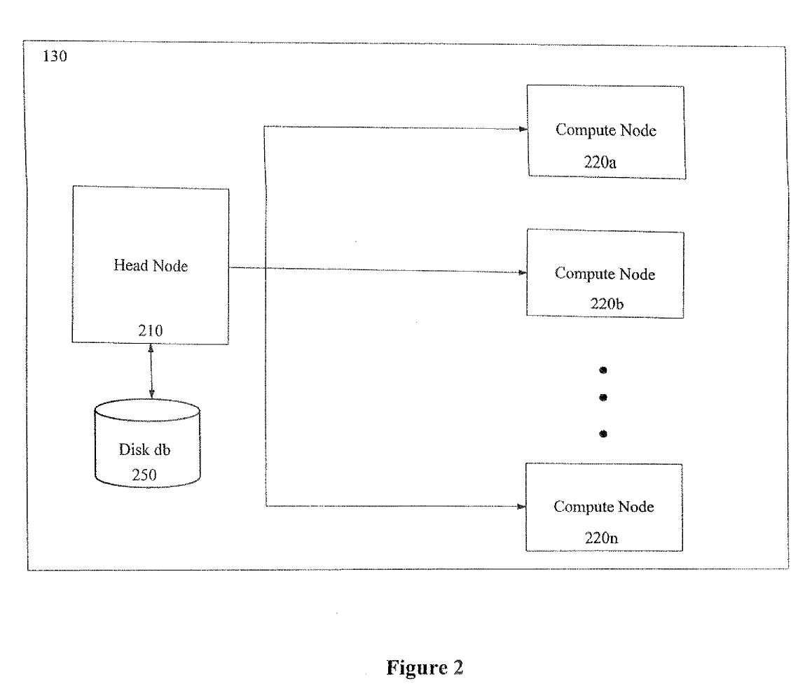

According to one embodiment, control unit 130 processes and renders objects received from print server 120 and provides sheet maps for printing to print engine 160. FIG. 2 illustrates one embodiment of a control unit 130. Control unit 130 includes a head node 210 and a multitude (e.g., ten) of compute node machines (compute nodes) 220a-220n.

Head node 210 receives print job data as IPDS data streams and separates the data into sheet sides that are forwarded to compute nodes 220a-220n for processing. According to one embodiment, head node 210 is coupled to a disk database 250. Disk database 250 is implemented to store previously processed image objects that are retrieved and used at compute nodes 220.

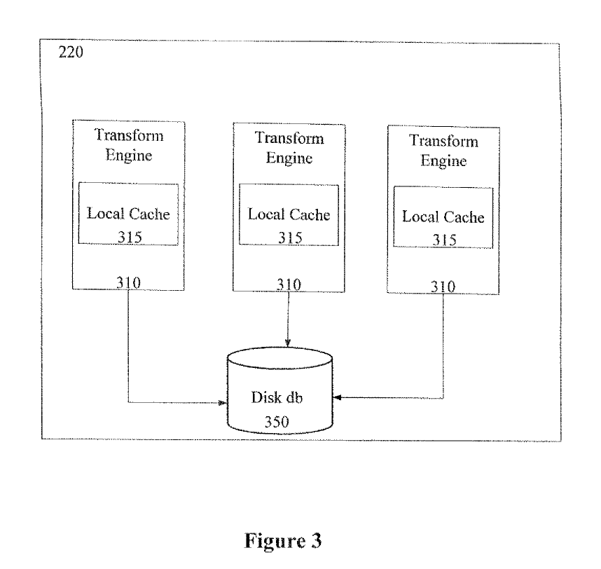

Compute nodes 220 rasterize the sheet sides received from head note 210. In one embodiment, each node 220 includes two or more parallel page output handlers (POH's). In a further embodiment, each POH includes a separate transform that processes received objects. FIG. 3 illustrates one embodiment of a compute node 220.

As shown in FIG. 3, node 220 includes transform engines (transforms) 310 implemented to process image objects by performing a raster image process (RIP) to produce a bitmap. However, in other embodiments, the transforms may process any type of data object received at control unit 130. Compute node 220 also includes a disk database 350 to store the object data.

Disk database 350 is central to each of the transforms 310 at node 220, and thus stores data for objects processed by all of the transforms 310. However, in a further embodiment, each transform 310 may include an associated memory database (or local cache) 315 that caches image objects that a corresponding transform 310 encounters more than once.

According to one embodiment, head node 210 recognizes how each object is received at control unit 130 and makes predictions as to whether the image will be used more than once (e.g., image used multiple times per page). In such an embodiment, head node 210 includes a local cache indicator along with bitmap data accessed from Disk Db 250 by a compute node 220. In one embodiment, the local cache indicator is a binary encoded value that provides information as to whether a bitmap should be cached locally on the compute node.

One value of the local cache indicator may indicate that the data is not to be cached locally. In one embodiment, head node 210 knows the overall configuration of control unit 130 and the relevant hardware aspects of print engine 160. Thus, an indication that retrieved data is not to be cached locally may likely be due to caching is turned off in the configuration, or because a Storage Area Network (SAN) is available and local caching would be undesirable.

In a further embodiment, a second value instructs that the retrieved bitmap must be cached locally at the compute node 220. In this embodiment, head node 210 recognizes that the image is used multiple times (e.g., many times per page). Another local cache indicator value may indicate that it is recommended that the bitmap be cached locally at the compute node 220. This value may occur because the image is referred to in an IPDS RPO indicating that there is a high likelihood that the image will be used again at the compute node 220 retrieving the bitmap.

Yet another local cache indicator value may indicate that locally caching the bitmap at the compute node 220 is not recommended. This value may indicate that the image is a saved page where it is unlikely the same saved page will be reused by the same compute node 220, or at least unlikely it will be reused often enough to make it worth the overhead of local caching.

Still another local cache indicator value may instruct the compute node 220 to cache the bitmap image if desired. This value may occur in instances where head node 210 does not have enough information to know whether to recommend caching. For any of the last three values, a compute node 220 may determine whether or not the image is to be cached locally.

According to one embodiment, a compute node 220 may use a process to make the determination. One such use process may be based on whether a retrieved bitmap has been used before. In other embodiments, processes may be based on how much cache space is available, or based on other criteria taking into account the recommendation from head node 210.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. Accordingly, the scope and spirit of the invention should be judged in terms of the claims which follow.

What is claimed is:

1. A method comprising:
a compute node retrieving an object;
the compute node receiving a local cache indicator associated with the object providing information as to whether the object is to be cached at the compute node; and
the compute node processing the object.

2. The method of claim 1 wherein the object is retrieved from a database and the local cache indicator received from a head node.

3. The method of claim 2 wherein the local cache indicator indicates that the object is not to be cached at the compute node.

4. The method of claim 2 wherein the local cache indicator indicates that the object must be cached at the compute node since the object is used multiple times at the compute node.

5. The method of claim 4 further comprising caching the object at a disk database within the compute node.

6. The method of claim 4 further comprising caching the object at a memory database within a transform engine at the compute node.

7. The method of claim 2 wherein the local cache indicator indicates that the object is recommended to be cached at the compute node since there is a high likelihood that the object will be used multiple times at the control node.

8. The method of claim 2 wherein the local cache indicator indicates that the object is not recommended to be cached at the compute node.

9. The method of claim 2 wherein the local cache indicator indicates that the compute node is to determine if the object is to be cached at the compute node.

10. The method of claim 9 wherein the compute node caches the object if the object has been previously used at the compute node.

11. The method of claim 9 wherein the compute node caches the object if cache space is available at the compute node.

12. A printing system comprising:
a print server; and
a printer comprising:
a print head; and
a control unit having:
a disk database;
a head node; and
a compute node to retrieve an object from the disk database, and receive a local cache indicator from the head node that is associated with the object providing information as to whether the object is to be cached at the compute node.

13. The printing system of claim 12 wherein the compute node comprises a local disk coupled to store the object.

14. The printing system of claim 13 wherein the compute node comprises a first image transform having a memory database to store the object.

15. The printing system of claim 12 wherein the local cache indicator provides an indication as to at least one of the following:
the object is not to be cached at the compute node, the object must be cached at the compute node, the object is recommended to be cached at the compute node, the object is not recommended to be cached at the compute node and the compute node is to determine if the object is to be cached at the compute node.

16. An article of manufacture comprising a machine-readable medium including data that, when accessed by a machine, cause the machine to perform operations comprising:
retrieving an object from a database;
receiving a local cache indicator associated with the object providing information as to whether the object is to be cached at the compute node; and
processing the object.

17. The article of manufacture of claim 16 wherein the local cache indicator provides an indication as to at least one of the following:
the object is not to be cached at the compute node, the object must be cached at the compute node, the object is recommended to be cached at the compute node, the object is not recommended to be cached at the compute node and the compute node is to determine if the object is to be cached at the compute node.

18. A printer comprising:
a control unit having:
a disk database;
a head node; and
a compute node to retrieve an object from the disk database, and receive a local cache indicator from the head node that is associated with the object providing information as to whether the object is to be cached at the compute node.

19. The printer of claim 18 wherein the compute node comprises a local disk coupled to store the object.

20. The printer of claim 18 wherein the compute node comprises a first image transform having a memory database to store the object.
